(19) United States
(12) Patent Application Publication
(10) Pub. No.: US 2016/0290862 A1
(43) Pub. Date: Oct. 6, 2016

(54) SEQUENTIAL ICP OPTICAL EMISSION SPECTROMETER AND METHOD FOR CORRECTING MEASUREMENT WAVELENGTH

(71) Applicant: HITACHI HIGH-TECH SCIENCE CORPORATION, Tokyo (JP)

(72) Inventor: Yutaka IKKU, Tokyo (JP)

(21) Appl. No.: 15/084,435

(22) Filed: Mar. 29, 2016

(30) Foreign Application Priority Data
Mar. 31, 2015 (JP) 2015-074069

(51) Int. Cl. G01J 3/02; G01N 21/73; G01J 3/443

(52) U.S. Cl. CPC G01J 3/027; G01J 3/443; G01N 21/73; G01N 2201/068

(57) ABSTRACT

A sequential inductively coupled plasma (ICP) optical emission spectrometer includes a controller that operates to perform a series of process based on a shift amount (time dependency) of a wavelength peak position according to time elapse of a reference wavelength obtained as a result of continuously measuring a plurality of emission lines of argon having different wavelengths as the reference wavelength and a per-wavelength shift amount (wavelength dependency) of the reference wavelength, the process including: calculating a shift amount of a wavelength peak position of each measurement wavelength from a standard sample measurement time to an unknown sample measurement time; and performing measurement wavelength correction for correcting the movement position of the diffracting grating corresponding to the wavelength peak position of the measurement wavelength relative to the initial position.

### CROSS-REFERENCE TO RELATED APPLICATION

This application claims priority from Japanese Patent Application No. 2015-074069, filed on Mar. 31, 2015, the entire subject matter of which is incorporated herein by reference.

### BACKGROUND

1. Field of the Invention

The present disclosure relates to a sequential inductively coupled plasma (ICP) optical emission spectrometer and a method for correcting measurement wavelength for introducing a sample into ICP and performing qualitative or quantitative analysis of elements contained in the sample.

2. Description of the Related Art

An ICP optical emission spectrometer is used to perform qualitative or quantitative analysis of elements contained in a sample. In the ICP optical emission spectrometer, a spectroscope for introducing gas such as argon and a sample solution into a plasma torch, applying a high frequency to generate plasma and spectrally dispersing the generated plasma light is used.

The spectroscope spectrally disperses the plasma light into a specific wavelength of an element and a detector measures the emission intensity of the wavelength. An optical system such as a spectroscope is generally placed in a box body (thermostat tank) having a temperature control mechanism to control a temperature to be constant, in order to suppress drift of a peak position generated from diffraction condition change corresponding to temperature change.

In order to maintain the temperature of the thermostat tank, a temperature control mechanism such as a heater, a blast fan, a temperature sensor, a temperature controller is generally mounted to control the temperature to be constant (a temperature higher than a room temperature). By making the temperature higher than the room temperature, a cooling function becomes unnecessary and the cost of the temperature control mechanism can be suppressed to some extent (see, for example, JP-A-H11(1999)-153543).

A disclosure of JP-A-2007-155631 relates to a multi-type (echelle-type) ICP optical emission spectrometer capable of simultaneously measuring a plurality of wavelengths by a detector including a plurality of micro photoreceiving elements. In this document, the angle of a telemeter mirror is mechanically and finely controlled to reduce influence of dislocation of the image of the detector due to temperature change or the like. That is, upon both background measurement and sample measurement, spectral images are obtained by argon emission. The size and direction of the dislocation are calculated from the information on two spectral images to finely control the angle of the telemeter mirror, and the positions of the spectral images on a two-dimensional detection surface are maintained at a substantially same place.

In the configuration disclosed in JP-A-H11(1999)-153543, in order to suppress diffraction condition change due to temperature change, the arrangement condition of the member such as the position of the temperature sensor, the heater, the blast fan or the like placed in the apparatus is hardly obtained by analysis and thus is generally determined by trial and error.

When the apparatus is modified, generally, it is necessary to change the arrangement condition of the above-described various members. However, whenever the arrangement condition is changed, confirmation experiments need to be performed and thus the quantity of work increases and the constraint condition on the modification of the apparatus becomes excessive.

The configuration disclosed in JP-A-2007-155631 is limited to application to the multi-type ICP optical emission spectrometer. In addition, a mechanism such as an actuator is necessary to control the angle or position of an optical element such as a telemeter mirror and thus costs increase.

### SUMMARY

The present disclosure has been made in view of such a problem and one of objects of the present disclosure is to provide a sequential ICP optical emission spectrometer and method for correcting measurement wavelength, which does not require a mechanism for mechanically moving a detector of a spectroscope or a temperature control mechanism.

According to an exemplary embodiment of the present disclosure, there is provided a sequential inductively coupled plasma (ICP) optical emission spectrometer including: an inductively coupled plasma generator that is configured to atomize or excite an element by inductively coupled plasma and to obtain an emission line of the element; a spectroscope configured to receive the emission line and spectrally dispersing and detecting the emission line using a diffracting grating; a detector configured to detect the emission line that is spectrally dispersed by the spectroscope; and a controller configured to analyze an element to be measured based on a wavelength peak position of the emission line detected in the detector. The controller operates to perform a series of process based on a shift amount (time dependency) of a wavelength peak position according to time elapse of a reference wavelength obtained as a result of continuously measuring a plurality of emission lines of argon having different wavelengths as the reference wavelength. The process includes: calculating a wavelength dependant shift amount of a wavelength peak position of each measurement wavelength from a standard sample measurement time to an unknown sample measurement time; and performing measurement wavelength correction for correcting the movement position of the diffracting grating corresponding to the wavelength peak position of the measurement wavelength relative to the initial position (=the position at the time of measuring a standard sample).

According to another exemplary embodiment of the present disclosure, there is provided a method for correcting measurement wavelength in a sequential inductively coupled plasma (ICP) optical emission spectrometer including: an inductively coupled plasma generator that is configured to atomize or excite an element by inductively coupled plasma and to obtain an emission line of the element; a spectroscope configured to receive the emission line and spectrally dispersing and detecting the emission line using a diffracting grating; a detector configured to detect the emission line that is spectrally dispersed by the spectroscope; and a controller configured to analyze an element to be measured based on a wavelength peak position of the emission line detected in the detector. The method includes: continuously measuring a plurality of emission lines of argon having different wavelengths as a reference wavelength; calculating a shift amount of a wavelength peak position of each measurement wavelength from a standard sample measurement time to an unknown sample measurement time using a shift amount (time dependency) of a wavelength peak position according to time elapse of the reference wavelength and a shift amount (wavelength dependency) of the reference wavelength for each wavelength of each element; and correcting the movement position of the diffracting grating corresponding to the wavelength peak position of the measurement wavelength upon measurement of an unknown sample containing the element to be measured.

According to the configuration of above, since a wavelength peak can be detected using a reference and temperature dependency can be corrected, the temperature control mechanism of the spectroscope becomes unnecessary. Thus, it is possible to downsize the body of the sequential ICP optical emission spectrometer.

### BRIEF DESCRIPTION OF THE DRAWINGS

The above and other aspects of the present disclosure will become more apparent and more readily appreciated from the following description of illustrative embodiments of the present disclosure taken in conjunction with the attached drawings, in which:

FIG. 1 is a diagram showing a concept of a sequential ICP optical emission spectrometer according to an embodiment of the present disclosure;

FIG. 2A is a diagram showing the concept of time change of a deviation ratio (=Δλ/λ) of a wavelength;

FIG. 2B is a diagram showing the concept of wavelength dependency of a peak shift amount Δp of a wavelength;

FIG. 3A is a diagram showing an example of selecting wavelengths λ_{Ar1} and λ_{Ar2} belonging to only a short wavelength side area of a measurement wavelength λ_{X} of an element to be measured as a reference wavelength; and

FIG. 3B is a diagram showing an example of selecting wavelengths λ_{Ar1} and λ_{Ar2} belonging to only a long wavelength side area of a measurement wavelength λ_{X} of an element to be measured as a reference wavelength.

### DETAILED DESCRIPTION

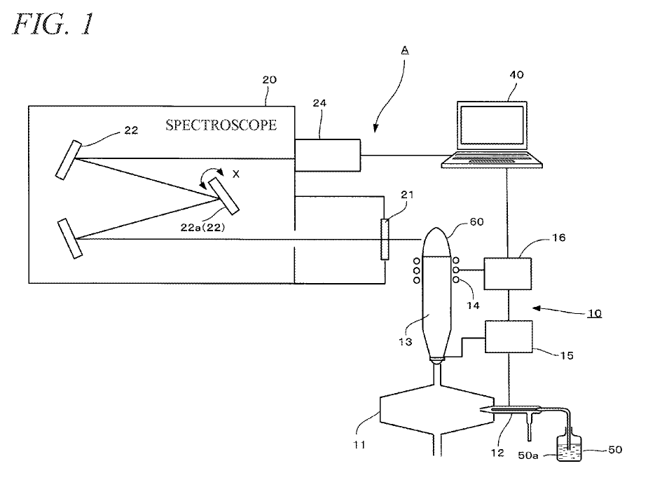

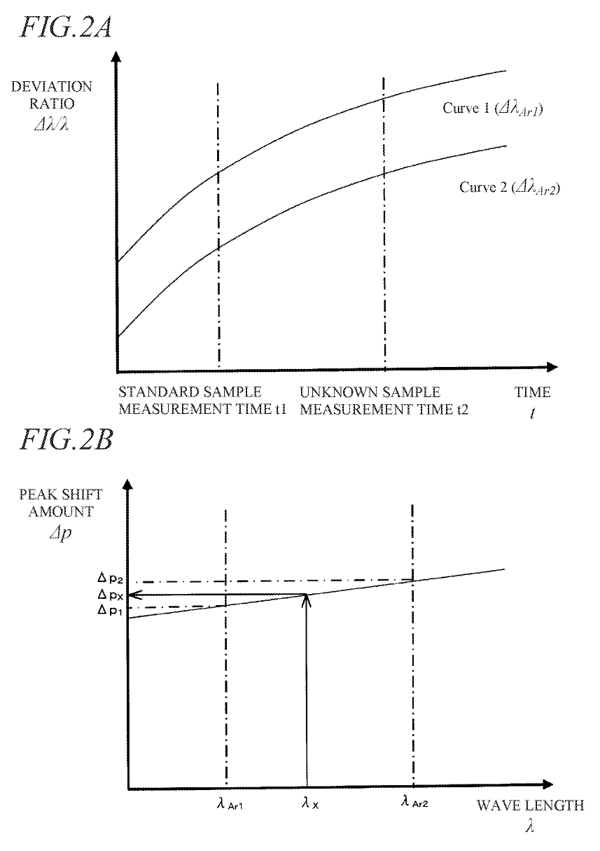

Hereinafter, an embodiment of a sequential inductively coupled plasma (ICP) optical emission spectrometer and a method for correcting measurement wavelength according to the present disclosure will be described with reference to FIGS. 1, 2A and 2B.

FIG. 1 is a diagram showing a concept of a sequential ICP optical emission spectrometer according to the embodiment. The sequential ICP optical emission spectrometer A includes a spectroscope 20 and a controller 40 in addition to an inductively coupled plasma generator 10 for exciting an element to be measured.

The inductively coupled plasma generator 10 includes a spray chamber 11, a nebulizer 12, a plasma torch 13, a high-frequency induction coil 14, a gas controller 15 and a high-frequency power source 16.

The spectroscope 20 includes an incident window 21, an optical component 22 such as a diffracting grating and a concave mirror, and a detector (detection unit) 24. The optical component 22 includes a diffracting grating 22a, and an actuating mechanism (not shown) that rotates the diffracting grating 22a as denoted by an arrow X and controls the angle (position) of the diffracting grating to spectrally disperse light from plasma incident to the spectroscope 20, thereby extracting an emission line having a specific wavelength corresponding to a specific element.

The controller 40 is a computer or the like and controls the entire sequential ICP optical emission spectrometer A, controls the spectroscope 20 according to an emission wavelength of each element to be detected, and measures emission intensity for each wavelength of each element to be measured and the emission intensity of the background wavelength position individually set by elements to be measured.

Carrier gas (argon) supplied into the nebulizer 12 is ejected from the front end of the nebulizer 12 into the spray chamber 11 at a flow rate of 0.8 L/min, for example. A sample solution 50a of a sample container 50 is sucked by negative suction of carrier gas such that the sample is sprayed from the front end of the nebulizer 12. The sprayed sample solution 50a is guided to the plasma torch 13 having a cylindrical pipe structure by particle homogenization and airflow stabilization in the spray chamber 11.

By high-frequency current from the high-frequency power source 16 to the high-frequency induction coil 14, the sample molecules (or atoms) of the sample solution 50a are heated and excited within the plasma 60 to emit light. The frequency of the high-frequency current is generally 27.12 MHz or 40 MHz and high-frequency power is about 500 W to 2000 W.

The emission lines atomized or excited by the plasma 60 of the element to be analyzed of the sample solution 50a are incident to the spectroscope 20 via the incident window 21. Emission line measurement information spectrally dispersed and detected in the spectroscope 20 is subjected to data processing and is analyzed in the controller 40 and qualitative analysis of the element (for example, a small amount of impurity elements) contained in the sample solution 50a from the wavelength thereof and quantitative analysis from the intensity thereof are performed. In the sample solution 50a, the below-described standard sample, an unknown sample or the like is included.

If the state, environment or the like of the sequential ICP optical emission spectrometer A is not changed during the measurement period, drift (displacement) does not occur in the wavelength peak position (the position of the wavelength in which a predetermined peak appears) of each element to be measured but the actual state, environment or the like of the apparatus are always changed. In particular, the drift of the peak wavelength due to temperature influence is large and temperature change according to time elapse is desired to be suppressed as much as possible. To this end, as described above, a device for making the temperature of the sequential ICP optical emission spectrometer, more particularly, the temperature of the spectroscope 20, constant has been designed by mounting a thermostat tank, a temperature control mechanism or the like for housing the spectroscope.

In the present embodiment, by using previously obtained data of the element to be measured of the standard sample and argon, time dependency and wavelength dependency of a shift amount occurring by the drift are obtained. In consideration of the dependency, the shift amount Δp of the wavelength peak position of the element at a measurement time t of the element to be measured of the unknown sample is calculated. This shift amount is set as a correction amount and the sequential ICP optical emission spectrometer A appropriately performs measurement by setting an appropriate measurement wavelength upon measurement of the unknown sample.

The sequential ICP optical emission spectrometer A performs an analysis method (including a method for correcting measurement wavelength) having the following processes.

1) Process of measuring the peak wavelength of a plurality of emission lines of argon having different wavelengths as a reference (reference wavelength), continuously performing measurement (preferably at a predetermined time interval) and storing a deviation ratio of a theoretical value (theoretical wavelength) and an actual measured value (measured reference wavelength) along with a measurement time (Process 1)

2) Process of calculating a deviation ratio of a reference wavelength at a time specified with respect to an emission line of argon from a plurality (for example, 2 times) of successive measurements of Process 1 (Process 2)

3) Process of storing the rotation position of the diffracting grating corresponding to the measurement wavelength peak position of the element to be measured at the time of standard sample measurements as an initial value, that is, the initial position of the diffracting grating, using the standard sample, along with the measurement time (Process 3)

4) Process of obtaining the peak shift amount of the reference wavelength from a difference between the deviation ratio of the reference wavelength calculated from Process 2 at a current time and the deviation ratio of the reference wavelength calculated from Process 2 at a standard sample measurement time and calculating the correction amount of the measurement wavelength from the wavelength dependency of the peak shift amount (Process 4)

5) Process of calculating the correction amount of the position of the diffracting grating to correspond to the correction amount getting from Process 4 of the measurement wavelength of the unknown sample (Process 5)

6) Process of setting the parameter of the spectroscope (setting the movement position of the diffracting grating 22a) based on Process 5 and measuring the emission intensity of the element of the unknown sample (Process 6).

In the present embodiment, the thermostat tank for maintaining the spectroscope 20 at a constant temperature or the temperature control mechanism including the heater is not included and may be omitted. Hereinafter, the analysis method performed by the sequential ICP optical emission spectrometer A of the present embodiment will be sequentially described.

In general, a time from measurement start to measurement completion of the sequential ICP optical emission spectrometer includes a measurement time and a non-measurement time. The measurement time refers to a time when the element to be measured of the sample is measured and the non-measurement time refers to a time when measurement of the sample is not performed and a sample introduction system such as the nebulizer 12 is cleaned or a standby time until preparation of a next sample is completed. In general, the measurement time and the non-measurement time are alternately provided.

When quantitative analysis is performed by the sequential ICP optical emission spectrometer, measurement of the standard sample including the element having a known concentration is first performed and the movement position of the diffracting rating corresponding to the measurement wavelength peak position of each element to be measured is determined to prepare the calibration line for quantitative measurement. Next, by measuring the emission intensity of the element to be measured of the unknown sample to be quantitatively analyzed and referring to the calibration line, it is possible to calculate the concentration of the element to be measured of the unknown sample.

As described above, since the state, environment or the like of the apparatus which is operating is always changed, the wavelength peak position of each element upon measurement of the unknown sample is changed (drifted) from the peak position upon measurement of the standard sample which should be originally a reference. The shift amount which is the amount of change has time dependency changed by the measurement time and wavelength dependency depending on the wave length itself This is schematically shown in FIGS. 2A and 2B. FIG. 2A is a graph schematically showing change (time dependency) of the deviation ratio Δλ/λ of the wavelength peak position at the measurement time t and FIG. 2B is a graph schematically showing wavelength dependency when a difference between the deviation ratio Δλ/λ(t1) at a time t1 and the deviation ratio Δλ/λ(t2) at a time t2 is defined as a peak shift amount Δp. As described later, the time t1 is the measurement time of the standard sample and the time t2 is the measurement time of the unknown sample, for example. Since the shift amount of the wavelength peak position of each element to be measured has time dependency and wavelength dependency, in the present embodiment, the peak shift amount Δp obtained per reference wavelength and the deviation ratio Δλ/λ considering the wavelength as well as the simple shift amount Δλ are used as an index for correcting change in wavelength peak position relative to the initial position.

In plasma 60 generated in the plasma torch 13, not only the emission line derived from the element to be originally qualitatively/quantitatively analyzed but also the emission line of argon (argon atom) introduced for generating plasma are present. That is, even when the sample is not introduced at the non-measurement time, the emission lines of argon are present in plasma 60. In the present disclosure, time dependency and wavelength dependency with respect to the emission lines of argon which are not qualitatively/quantitatively analyzed, are obtained and the measurement wavelength of the element to be measured of the unknown sample is corrected using time dependency and wavelength dependency with respect to the emission lines of argon as a reference.

That is, the sequential ICP optical emission spectrometer A of the present embodiment continuously, repeatedly and automatically measures the peak wavelengths of a plurality of emission lines of argon (plasma generation/sample introduction gas) having different wavelengths as a reference wavelength at regular intervals from measurement start. The controller 40 stores each measurement time and the deviation ratios of the wavelength peak position (obtained by dividing the difference between the measured reference wavelength and the theoretical value by the reference wavelength) in a storage device (memory). The theoretical value includes a peak wavelength value (theoretical wavelength) provided by National Institute of Standards and Technology (NIST), for example. The storage of the deviation ratios of the wavelength peak position of argon is continuously performed at a time when the standard sample and the unknown sample are not measured.

Actually, an operator sets the standard sample in the sequential ICP optical emission spectrometer A and manipulates the controller 40 to start measurement.

The controller 40 stores the deviation ratios of the peak positions (peak wavelengths) and the measurement times with respect to the repeatedly measured reference wavelengths of the argon in the storage device as reference peak information (Process 1). In addition, the controller 40 calculates the deviation ratio of the wavelength peak position of each reference wavelength at an arbitrary time from the deviation ratios of the plurality (for example, two) of stored wavelength peak positions and the measurement times (Process 2).

In measurement of the standard sample S1 of the element to be measured, when the peak of the measurement wavelength is detected, the controller 40 stores the rotation position of the diffracting grating 22a corresponding to the peak position as an initial position along with the measurement time. In addition, measurement is sequentially performed with respect to the standard samples S2, S3, . . . in which the concentrations of various elements including the element to be measured are changed, and the initial position and measurement time of the diffracting grating 22a in each measurement wavelength are stored along with the calibration line (Process 3).

Measurement of the unknown sample is performed after measurement of the standard sample. Here, at the measurement time t2 (generally, the current time) of the unknown sample, in process 2, the deviation ratio of the wavelength peak position of the reference wavelength of argon is calculated by the controller 40. In addition, even at the measurement time t1 of the standard sample, in process 2, the deviation ratio of the wavelength peak position of the reference wavelength of argon is calculated by the controller 40. The difference between the deviation ratio of the wavelength peak position of the reference wavelength at the measurement time of the standard sample and the deviation ratio of the wavelength peak position of the reference wavelength at the measurement time (generally, the current time) of the unknown sample becomes a peak shift amount of each reference wavelength. Wavelength dependency of the peak shift amount of the reference wavelength is approximated to a straight line and the peak shift amount of an arbitrary measurement wavelength is obtained from the obtained approximate curve and the correction amount of the measurement wavelength is calculated from the wavelength dependency of the peak shift amount (Process 4).

After standard sample measurement, even when measuring the unknown sample, argon is repeatedly measured at the non-measurement time.

The parameters “a” and “b” of the equation approximated to the straight line in order to obtain the approximate curve may be obtained by a least-squares method, for example. For example, when two reference wavelengths of argon are λ_{Ar1} and λ_{Ar2} and the peak shift amounts of the two reference wavelengths are Δp₁ and Δp₂ (see FIG. 2B), since the following approximate equation (1) is satisfied, the parameters “a” and “b: may be obtained.

Δp₁=a×λ_{Ar1}+b

ΔP₂=a×λ_{AR2}+b (1)

where, Δp=a×λ+b

Each curve (graph) shown in FIG. 2A represents temporal change (time dependency) of the deviation ratio of the wavelength peak position of the reference wavelength of argon. That is, Curve 1 shows time dependency of the deviation ratio Δλ_{Ar1}/λ_{Ar1} of the wavelength peak position of one reference wavelength λ_{Ar1} of the wavelengths of argon. Curve 2 shows time dependency of the deviation ratio Δλ_{Ar2}/λ_{Ar2} of the wavelength peak position of the other reference wavelength λ_{Ar2} of the wavelengths of argon. For example, when the standard sample measurement time is t1 and the unknown sample measurement time is t2, the difference between Δλ_{Ar1}(t1)/λ_{Ar1} of the standard sample measurement time t1 and the Δλ_{Ar1}(t2)/λ_{Ar1} of the unknown sample measurement time t2 in Curve 1 becomes the peak shift amount Δp₁(=λ_{Ar1}(t2)/λ_{Ar1}−Δλ_{Ar1})/λ_{Ar1}). The difference between Δλ_{Ar2}(t1)/λ_{Ar2} of the standard sample measurement time t1 and the Δλ_{Ar2}(t2)/λ_{Ar2} of the unknown sample measurement time t2 in Curve 2 becomes the peak shift amount Δp₂(=Δλ_{Ar2}(t2)/λ_{Ar2}−Δλ_{Ar2}(t1)/λ_{Ar2}).

The graph of the peak shift amounts Δp of the two curves obtained with respect to the wavelength on the horizontal axis is shown in FIG. 2B. The peak shift amount Δp of an arbitrary wavelength may be calculated from a straight line connecting the two points. That is, when each measurement wavelength upon unknown sample measurement is the above-described arbitrary wavelength, the shift amount from the peak position upon standard sample measurement, that is, the so-called peak shift amount, may be calculated. In FIG. 2B, the controller 40 sets one reference wavelength λ_{Ar1} to the short wavelength side area of the measurement wavelength, sets the other reference λ_{Ar2} to the long wavelength side area of the measurement wavelength and calculates the peak shift amount Δp_{X} of the measurement wavelength λ_{X} upon unknown sample measurement between the two reference wavelengths λ_{Ar1} and λ_{Ar2}.

Upon unknown sample measurement, the controller 40 calculates a correction amount for moving the diffracting grating 22a by the correction amount of the measurement wavelength calculated from the peak shift amount obtained in Process 4 relative to the initial position of the diffracting grating 22a upon measurement of the element to be measured of the standard sample obtained in Process 3, for the measurement wavelength of each element to be measured (Process 5). That is, the controller 40 may convert the peak shift amount into the position correction amount of the diffracting grating 22a to correct the position of the diffracting grating 22a upon unknown sample measurement by the position correction amount from the initial position upon standard correction amount. Thereafter, the controller 40 moves the diffracting grating 22a to a corrected movement position and measures the emission intensity of the unknown sample under the same condition as the condition at measuring the standard sample (Process 6).

As described above, this correction is performed by changing the movement position (or angle) of the diffracting grating 22a as denoted by an arrow X (see FIG. 1) in the sequential ICP optical emission spectrometer A. The controller 40 transmits a control signal to a rotation movement mechanism (not shown) formed in the spectroscope 20 and the rotation movement mechanism rotates the diffracting grating 22a as denoted by an arrow X.

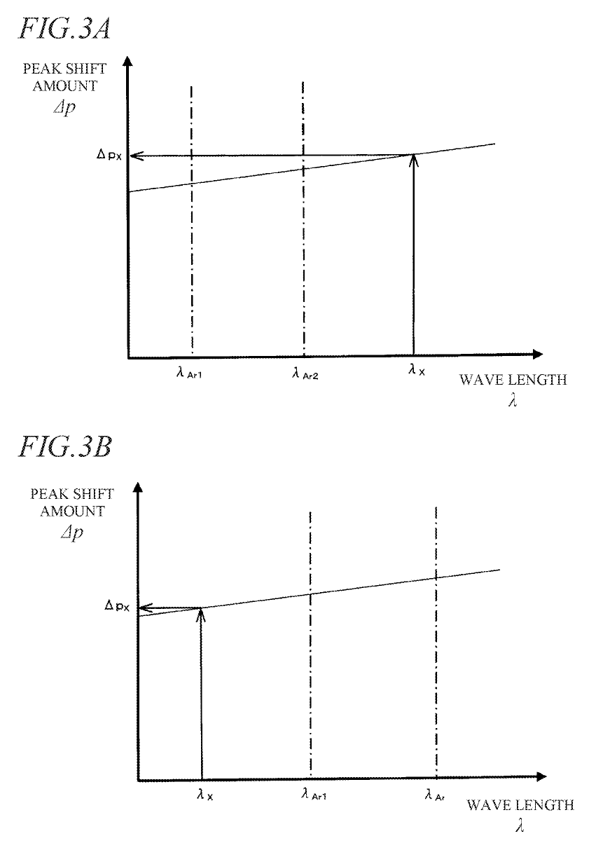

In addition, in FIG. 2B, as the wavelengths λ_{Ar1} and λ_{Ar2} of the emission line of argon selected as the reference wavelength, wavelengths belonging to both the short wavelength side area and the long wavelength side area of the measurement wavelength λₓ of the element to be measured are selected. The same correction may be performed even when a plurality of wavelengths belonging to any of the short wavelength side area or the long wavelength side area of the measurement wavelength of the element to be measured as the reference wavelength. FIG. 3A shows an example of selecting two reference wavelengths λ_{Ar1} and λ_{Ar2} belonging to the short wavelength side area of the measurement wavelength λ_{X} of the element to be measured and FIG. 3B shows an example of selecting two reference wavelengths λ_{Ar1} and λ_{Ar2} belonging to the long wavelength side area of the measurement wavelength λ_{X} of the element to be measured.

In FIGS. 2A through 3B, the controller 40 calculates the peak shift amount Δp of the measurement wavelength of the unknown sample using the two different reference wavelengths λ_{Ar1} and λ_{Ar2} of argon. However, the number of used reference wavelengths of argon is not limited to two and three or more reference wavelengths may be used. That is, in FIGS. 2B, 3A and 3B, a straight line of wavelength dependency may be obtained from the peak shift amounts Δp of three points by least squares approximation.

In the present embodiment, the controller 40 continuously measures the wavelength peak positions of a plurality of emission lines of argon having different wavelengths and calculates temporal change of the wavelength peak position of the emission line for detecting the element to be measured based on time dependency of the wavelength peak position of argon of each wavelength and the controller 40 corrects the movement position of the diffracting grating 22a corresponding to the measurement wavelength of the unknown sample containing the element to be measured, relative to the initial position. More specifically, as shown in Curve 1 or Curve 2 of FIG. 2A, the controller 40 calculates a shift amount between the wavelength peak position of each emission line of argon at a measurement time t1 of the standard sample and the wavelength peak position of each emission line of argon at a measurement time t2 of the unknown sample and calculates the correction amount of time dependency in the measurement wavelength of each element to be measured of the unknown sample. Accordingly, the sequential ICP optical emission spectrometer A may measure the element to be measured of the unknown sample at the appropriate movement position of the diffracting grating 22a, that is, in the appropriate measurement wavelength.

In the present embodiment, the controller 40 continuously measures the wavelength peak position of the emission line of argon as the reference wavelength with respect to a plurality of different wavelengths to measure a shift amount according to the different wavelengths and calculates the correction amount of wavelength dependency of the measurement wavelength using the shift amount of the reference wavelength in the vicinity of the measurement wavelength (in the vicinity of the wavelength peak position of the measurement wavelength). More specifically, the controller 40 calculates the deviation ratio Δλ/λ in the different wavelengths λ_{Ar1} and λ_{Ar2}. The controller 40 calculates the deviation ratio (Δλ_{Ar1}(t1)/λ_{Ar1}) at the standard sample measurement time t1 and the deviation ratio (Δλ_{Ar1}(t2)/λ_{Ar1}) at the unknown sample measurement time t2, with respect to the reference wavelength λ_{Ar1}. In addition, the controller 40 calculates the peak shift amount Δp₁(=Δλ_{Ar1}(t2)/λ_{Ar1}−λ_{Ar1}(t1)/λ_{Ar1}) which is a difference between the two deviation ratios.

The controller 40 calculates the deviation ratio (Δλ_{Ar2}(t1)/λ_{Ar2}) at the standard sample measurement time t1 and the deviation ratio (Δλ_{Ar2}(t2)/λ_{Ar2}) at the unknown sample measurement time t2, with respect to the reference wavelength λ_{Ar2}. In addition, the controller 40 calculates the peak shift amount Δp₂ (=Δλ_{Ar2}(t2)/λ_{Ar2}−λ_{Ar2}(t1)/λ_{Ar2}) which is a difference between the two deviation ratios.

That is, the controller 40 may calculate the peak shift amount of each of the different reference wavelengths and thus calculate the correction amount of the measurement wavelength considering not only time dependency but also wavelength dependency. Accordingly, the sequential ICP optical emission spectrometer A may measure the element to be measured of the unknown sample at the appropriate movement position of the diffracting grating 22a, that is, in the appropriate measurement wavelength.

The reference wavelength of argon is preferably selected from the vicinity of the wavelength peak position of the measurement wavelength of the element to be measured. By such selection, it is possible to correct the measurement wavelength with high precision.

In the above-described embodiment, the method of measuring a plurality of emission lines of argon having different wavelengths as reference to improve reliability of the peak shift amount was described. Here, the light from the diffracting grating 22a includes diffracted light and reflected light (zero-order light). This zero-order light may be measured as one reference, similarly to the emission line of argon, and may be used as a correction amount.

In addition, the present disclosure is applicable to a sequential ICP optical emission spectrometer attached with an automatic sampler (automatic sampling apparatus). In this apparatus, a plurality of unknown samples is mounted in the automatic sampler and is continuously measured. In such an apparatus, in general, a standby time is small and thus reference peak measurement of argon cannot be performed.

Therefore, in this apparatus, reference peak measurement of argon is forcedly performed. A predetermined time interval of reference measurement of argon is set and, when the predetermined time has elapsed from a previous reference measurement time, measurement of a sample to be measured is stopped and reference measurement is performed. After reference measurement, measurement of the sample to be measured is resumed.

In addition, the present disclosure is applicable to a sequential ICP optical emission spectrometer having a thermostat tank or a temperature control mechanism including a heater, a blast fan, a temperature sensor, a temperature controller or the like. However, by omitting the thermostat tank or the temperature control mechanism, confirmation experiments or the like becomes unnecessary upon changing the arrangement condition and the design of the apparatus may be easily modified or improved. In addition, costs may be reduced.

In addition, by mounting the thermostat or the temperature control mechanism to set the temperature to be higher than the room temperature, dark current of the sensor used in light detection increases and a measured value (background intensity) when there is no signal intensity increases, such that a phenomenon that a signal to background (SB) ratio decreases occurs. The present disclosure can suppress this phenomenon.

The present disclosure is not limited to the above-described embodiment and may be appropriately modified and improved. The material, shape, dimension, numerical value, form and position of each component and the number of components are arbitrarily set and are not limited if the present disclosure may be achieved.

According to the present disclosure, it is possible to realize a sequential ICP optical emission spectrometer and method for correcting measurement wavelength, which does not require a mechanism for mechanically moving an optical element of a spectroscope or a temperature control mechanism.

According to the present disclosure, since it is unnecessary to add an additive control mechanism to a temperature control mechanism or optical element of a spectroscope, it is possible to downsize the body of a sequential ICP optical emission spectrometer and to suppress costs. Since the apparatus can easily be modified and a measurement wavelength can be corrected with high precision, it is possible to improve detection accuracy of a peak wavelength.

What is claimed is:

1. A sequential inductively coupled plasma (ICP) optical emission spectrometer comprising:
an inductively coupled plasma generator that is configured to atomize or excite an element by inductively coupled plasma and to obtain an emission line of the element;
a spectroscope configured to receive the emission line and spectrally dispersing and detecting the emission line using a diffracting grating;
a detector configured to detect the emission line that is spectrally dispersed by the spectroscope; and
a controller configured to analyze an element to be measured based on a wavelength peak position of the emission line detected in the detector,
wherein the controller operates to perform a series of process based on a shift amount (time dependency) of a wavelength peak position according to time elapse of a reference wavelength obtained as a result of continuously measuring a plurality of emission lines of argon having different wavelengths as the reference wavelength and a shift amount (wavelength dependency) of the reference wavelength for each wavelength of each element, the process comprising:
calculating a shift amount of a wavelength peak position of each measurement wavelength from a standard sample measurement time to an unknown sample measurement time; and
performing measurement wavelength correction for correcting the movement position of the diffracting grating corresponding to the wavelength peak position of the measurement wavelength relative to the standard sample measurement time.

2. The sequential ICP optical emission spectrometer according to claim 1,
wherein, as the reference wavelength used as a correction amount relative to the initial position when calculating the shift amount of the wavelength peak position of the measurement wavelength of each element to be measured set upon the standard sample measurement time, a wavelength in the vicinity of the wavelength peak position of the measurement wavelength of the element to be measured is used.

3. The sequential ICP optical emission spectrometer according to claim 1,
wherein a plurality of reference wavelengths belong to a short wavelength side area and a long wavelength side area of a measurement wavelength of an unknown sample.

4. The sequential ICP optical emission spectrometer according to claim 1,
wherein a plurality of reference wavelengths belong to any one of a short wavelength side area or a long wavelength side area of a measurement wavelength of an unknown sample.

5. A method for correcting measurement wavelength in a sequential inductively coupled plasma (ICP) optical emission spectrometer including:
an inductively coupled plasma generator that is configured to atomize or excite an element by inductively coupled plasma and to obtain an emission line of the element;
a spectroscope configured to receive the emission line and spectrally dispersing and detecting the emission line using a diffracting grating;
a detector configured to detect the emission line that is spectrally dispersed by the spectroscope; and
a controller configured to analyze an element to be measured based on a wavelength peak position of the emission line detected in the detector,
wherein the method comprises:
continuously measuring a plurality of emission lines of argon having different wavelengths as a reference wavelength;
calculating a shift amount of a wavelength peak position of each measurement wavelength from a standard sample measurement time to an unknown sample measurement time using a shift amount (time dependency) of a wavelength peak position according to time elapse of the reference wavelength and a shift amount (wavelength dependency)of the reference wavelength for each wavelength of each element; and
correcting the movement position of the diffracting grating corresponding to the wavelength peak position of the measurement wavelength upon measurement of an unknown sample containing the element to be measured.
